(19) United States
(12) Patent Application Publication
(10) Pub. No.: US 2001/0045725 A1
(43) Pub. Date: Nov. 29, 2001

(54) Spring-loaded quick connect interchangerable hitch ball assembly

(76) Inventors: Richard W. McCoy, Granger, IN (US); Chad A. McCoige, Orlando, FL (US)

Correspondence Address: KING & SCHICKLI, PLLC, 247 NORTH BROADWAY, LEXINGTON, KY, 40507, US

(21) Appl. No.: 09/792,837

(22) Filed: Feb. 23, 2001

Related U.S. Application Data
(60) Provisional application No. 60/184,738, filed on Feb. 24, 2000.

(51) Int. Cl. B60D 1/06

(52) U.S. Cl. 280/511

(57) ABSTRACT

An interchangeable hitch ball assembly includes a towing ball having a mounting aperture and an annular race in communication with the mounting aperture. A post includes a base, a threaded axial bore and a plurality of openings in communication with the axial bore. A ball bearing is received in each of these openings. A threaded plunger is axially displaceable in the post between a first position allowing the towing ball to be removed from or attached to the post and a second position for securing the towing ball to the post while allowing the towing ball to turn on the post. A spring, received in the axial bore, engages an end of the plunger and biases the plunger to the first position.

This application claims the benefit of U.S. Provisional Application No. 60/184,738, filed Feb. 24, 2000.

### TECHNICAL FIELD

The present invention relates generally to the towing field and, more particularly, to a spring-loaded interchangeable hitch ball assembly which allows an operator to quickly and conveniently change from one size towing ball to another in order to meet the needs of any particular application.

### BACKGROUND OF THE INVENTION

The use of a ball joint coupling comprising a towing ball and cooperating socket assembly in order to tow a trailer behind a towing vehicle is well known in the art. Such an arrangement provides the necessary freedom of movement to allow a trailer to track smoothly behind the towing vehicle while also providing a dependable connection.

Over the years, towing balls of various diameters have been used for this purpose and several industry standard sizes (e.g. 1⅞ inch, 2 inch, 2¼ inch and 2 5/16 inch in diameter) are now in frequent use. As a result, it is not uncommon for a single towing vehicle to be used to tow various trailers where those trailers are equipped with socket assemblies adapted for operative connection with towing balls of different diameters. Thus, a need is identified for a hitch ball assembly allowing easy and convenient interchange of towing balls of different diameter so that the hitch of the towing vehicle may be tailored to fit the socket assembly of the trailer to be towed and thereby meet application needs.

Toward this end, a number of approaches have been proposed in the past. Representative of the interchangeable hitch ball art are U.S. Pat Nos. 4,433,854 to Smith, 5,419,576 to Van Vleet, 5,116,072 to Swenson and 4,522,421 to Vance.

The Smith '854 patent discloses a post for a towing ball incorporating a spring-biased latch pin for releasably attaching the towing ball to the base. The Van Vleet '576 patent discloses a post and towing ball secured together by means of a fastening pin. While the approaches disclosed in these patents provide secure connection of the towing ball to the post, the latch pins prevent rotation of the towing ball relative to the post. Such rotation is desirable as it minimizes binding forces and promotes articulation and smooth trailer tracking at both highway speeds and when maneuvering slowly in confined areas.

The Swenson '072 patent discloses an interchangeable hitch ball assembly including a post having an annular groove. The towing ball is secured to the post by means of an offset pin which extends tangentially through the annular groove so as to allow relative rotation of the towing ball on the post. There, however, is some difficulty in effectively securing the pin in position and the structure proposed in the Swenson patent for this purpose is relatively expensive to produce.

The Vance '421 patent discloses an interchangeable trailer ball assembly incorporating a mounting post including a threaded stem, a base, an axial bore and a pair of laterally extending bores. A tapered plunger is received in the axial bore. The plunger is biased by means of a spring into a position wherein ball bearings are forced outwardly into engagement with an annular groove or race in the towing ball thereby locking the towing ball in position on the post. An actuator rod may be extended into the axial bore to engage and lift the plunger so as to release the ball bearings from the groove or race and allow removal of the towing ball.

While very effective for its intended purpose, the interchangeable hitch ball assembly disclosed in the Vance '421 patent does suffer several shortcomings. First and foremost, secure and effective attachment of the towing ball to the post relies entirely upon the proper functioning of the spring. The spring, of course, has a tendency to lose biasing force over time as a result of wear and tear as well as exposure to the environmental elements. In extreme conditions of use and environmental temperature, the spring may actually fail leading directly to the failure of the connection between the towing ball and the post. Since the spring is completely internal and not subject to visual inspection, the prospect for potential problems is increased.

A need is therefore identified for an improved interchangeable hitch ball assembly.

### SUMMARY OF THE INVENTION

Additional advantages and other novel features of the invention will be set forth in part in the description that follows and in part will become apparent to those skilled in the art upon examination of the following or may be learned with the practice of the invention. The advantages of the invention may be realized and obtained by means of the instrumentalities and combinations particularly pointed out in the appended claims.

In accordance with the purpose of the present invention as described herein, an improved interchangeable hitch ball assembly is provided. The interchangeable hitch ball assembly includes a towing ball having a mounting aperture and an annular race in communication with that mounting aperture. The interchangeable hitch ball assembly also includes a post having a base, a threaded axial bore and a plurality of openings in communication with that axial bore. Additionally, the assembly includes a plurality of ball bearings, each of the plurality of ball bearings being received in one of the plurality of openings. Still further, the assembly includes a threaded plunger having a first segment of relatively small diameter, a second segment of relatively large diameter and a frustoconical cam surface extending between the two segments.

The plunger is axially displaceable in the post between a first position, wherein the first segment engages the plurality of ball bearings thereby allowing the plurality of ball bearings to be held substantially within the plurality of openings of the post and a second position, wherein the second segment engages the plurality of ball bearings forcing the ball bearings to project from the openings into the annular race of the towing ball so as to secure the towing ball to the post while allowing the towing ball to rotate relative to the post.

A spring is received in the bottom of the axial bore. The spring engages the lowermost end of the threaded plunger and biases that plunger toward the first position. Consequently, when the threaded plunger is fully loosened and disengaged from the treaded axial bore of the post, the spring biases/displaces the plunger upward to the first position, fully disengaging the ball bearings from the race in the hitch ball. In this position, the top of the plunger projects from the top of the hitch ball thereby also providing a visual indication of the connection condition of the plunger with respect to the post.

Still further describing the invention, the post includes a threaded mounting stem depending from the base. A cooperating lock washer and nut or a locknut may be used to engage this stem and secure the post to a hitch bar or tow bar which may be secured to the towing vehicle in any manner well known in the art.

Still further describing the invention, the post is tapered and the mounting aperture is tapered to match the post. Further, the mounting aperture extends through the towing ball and the plunger includes a slotted head which may be engaged by a tool, such as a screwdriver, to rotate and thereby displace the plunger between the first and second positions. Additionally, the outer edges of the post defining the plurality of openings are staked so as to retain the plurality of ball bearings in the post when the towing ball is removed to allow replacement with another towing ball of the same or different size as desired by the operator.

Additionally, a groove extends continuously around the second segment of the threaded plunger and a resilient retaining ring is received in that groove. A cooperating retaining channel in the post extends circumferentially around the axial bore. The retaining ring carried on the plunger is partially received in this retaining channel so as to retain the plunger in the post and prevent its advertent removal. With the plunger held in place, the ball bearings are also retained in position in the post openings.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention and together with the description serves to explain the principals of the invention. In the drawing:

FIG. 1a is a perspective view of the present invention;

FIG. 1b is a side elevational view of the present invention shown attached to a hitch or draw bar;

FIG. 2 is a cross sectional partially exploded view showing the hitch ball and post of the interchangeable hitch ball assembly of the present invention;

FIG. 3 is a detailed cross sectional view showing the hitch ball on the post with the plunger biased upwardly into the first or unlocked position with the end of the plunger extending through and above the hitch ball so as to provide a clear visual indication of the unlocked condition of the plunger; and

FIG. 4 is a detailed cross sectional view along line 4-4 of FIG. 1b showing the threaded plunger in the second, locked position wherein it is tightened in the axial bore of the post and functions to lock the hitch ball in position on the post.

Reference will now be made in detail to the present preferred embodiment of the invention, an example of which is illustrated in the accompanying drawing.

### DETAILED DESCRIPTION OF THE INVENTION

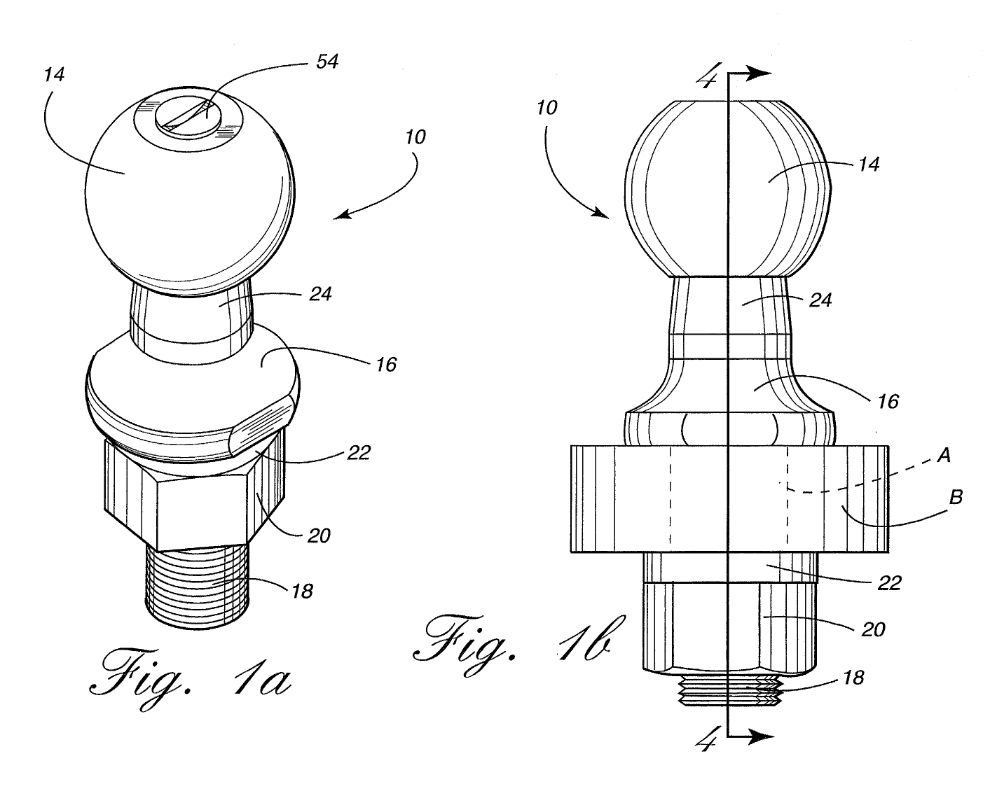

Reference is now made to FIGS. 1-4 showing the interchangeable hitch ball assembly 10 of the present invention. The assembly 10 includes a post generally designated by reference numeral 12 and a towing ball 14. As shown, the post 12 includes a base 16. A threaded stem 18 depends from the base. The post 12 is mounted to a hitch bar or draw bar B by extending the threaded stem 18 through an aperture A in the hitch bar B so that the base 16 rests flat on the hitch bar. A cooperating nut 20 and lock washer 22 are then engaged over the threaded stem 18. The nut 20 is tightened to provide a secure connection. Of course, a locknut could be utilized in place of the cooperating nut 20 and lock washer 22.

The post 12 includes a tapered upper portion 24 which has an axial bore 26 and threads 28 at the lower end thereof. A plurality of openings 30 extend through the wall of the tapered upper portion 24 and communicate with the axial bore 26. Two opposed openings 30 are shown in FIG. 1. Preferably, other openings (not shown) are provided in the same plane radially around the circumference of the tapered upper portion 24. A ball bearing 32 is provided in each of the openings 30. Preferably, the edges of the outer wall of the tapered upper portion 24 defining the openings 30 are staked so as to retain the ball bearings 32 in the openings 30.

A threaded plunger 36 is secured in the axial bore 26 by engagement with the threaded lower end 28 of the bore (see particularly FIG. 4). The plunger 36 includes a first segment 38 of relatively small diameter, a second segment 40 of relatively large diameter and a frustoconical cam surface 42 extending between the first and second segments. The plunger 36 is axially displaceable within the bore 26 between first and second positions in a manner described in greater detail below in order to selectively secure the towing ball 14 to the post 12 or release the towing ball from the post.

A compression spring 43 is seated in the bottom of the axial bore 26 with the uppermost end thereof engaging the bottommost face of the plunger 36. As will be described in greater detail below, the spring 43 functions to bias the plunger 36 toward and into the first or unlocked position.

The towing ball 14 includes a mounting aperture 44 tapered to match the tapered upper portion 24 of the post 12 and an annular race 46 extending circumferentially around and in communication with the mounting aperture 44. The annular race 46 is sized and shaped to receive the ball bearings 32 in the manner shown in FIG. 4.

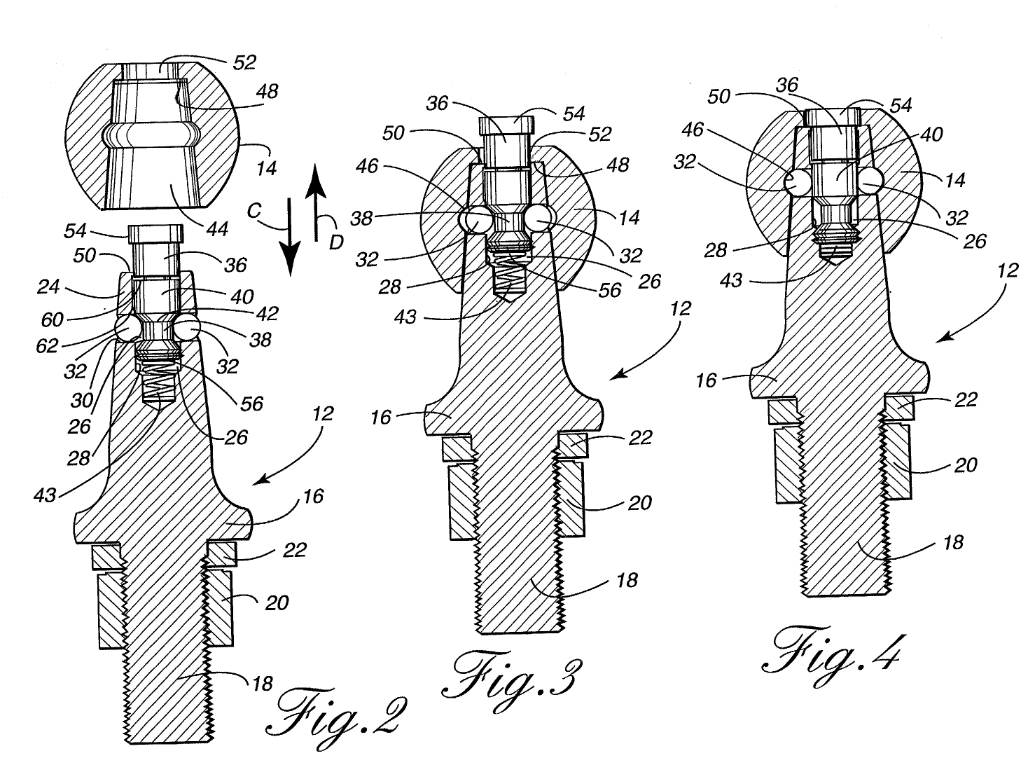

The mounting of the towing ball 14 on the post 12 is best illustrated with reference to both drawing FIGS. 2 and 3. Specifically, the plunger 36 is loosened from the axial bore 26 of the post 12 and thereby displaced under the biasing force of the spring 43 into the first or unlocked position. This is accomplished by turning the plunger 36 counterclockwise with respect to the post 12. In the first position shown in FIG. 2, the first, small diameter segment 38 of the plunger engages the ball bearings 32. As a result, the necessary clearance is provided in the axial bore 26 to accommodate the ball bearings 32 so that the ball bearings are fully received within the openings 30 and do not extend outwardly beyond the wall of the tapered upper portion 24 of the post 12. The towing ball 14 is then positioned downwardly in the direction of action arrow C. An annular shoulder 48 at the end of the mounting aperture 44 engages the upper edge 50 of the post 12 when the towing ball 14 is fully seated on the post 12 (see FIG. 3). In the seated position, the race 46 in the towing ball 14 is provided in the same plane with the openings 30 and ball bearings 32 in the post 12. Under the biasing force of the spring 43, the end of the plunger 36 is positively held in a position where it projects above the top of the towing ball 14 seated on the post 12. This gives a clear visual indication that the plunger 36 is in the unlocked position.

The towing ball 14 is secured in position on the post 12 by tightening the plunger 36 in the axial bore 26 of the post 12. Specifically, a cylindrical opening 52 is provided in the top of the towing ball 14 in communication with the mounting aperture 44. The plunger 36 includes a slotted head 54 at the upper end thereof. The cylindrical opening 52 is sized to provide just sufficient clearance to allow the passage of the head 54 of the plunger 36. The slotted head 54 of the plunger may be engaged with a screwdriver or other tool and tightened by turning clockwise relative to the post 12. Threads 56 on the plunger 36 engage and cooperate with the threads 28 on the upper portion 24 of the post 12. As a consequence, the plunger 36 is displaced into the second position shown in FIG. 3. Preferably, a single 360° turn of the plunger 36 completes the connection of the plunger with the post 12. The biasing force of the spring 43 is, of course, easily overcome.

As the plunger 36 is tightened, the cam surface 42 engages the ball bearings 32 forcing the ball bearings to project outwardly through the wall of the tapered upper portion 24 of the post 12 so that they extend into the race 46 provided in the towing ball 14. Once the plunger 36 is fully engaged in the second position, the second, relatively large diameter segment 40 of the plunger 36 substantially fills the axial bore 26 so that the ball bearings 32 are maintained in the projected position in full engagement with the race 46 of the towing ball 14. This ensures secure connection of the towing ball 14 with the post 12 . In addition, the ball bearings 32 and race 46 cooperate to allow relative rotation of the towing ball 14 on the post 12. This rotation helps ensure binding free towing and smooth trailer tracking under substantially any foreseeable operating conditions. This relative rotation prevents the ball from freezing in place and reduces the wear on the ball and the trailer socket assembly. Further, since the towing ball 14 turns freely on the post 12 during towing operation, the turning movement of the trailer does not turn the post 12 and any resulting inadvertent loosening of the nut 20 from the stem 18 of the post is avoided.

As also shown in FIG. 3, the plunger 36 includes a groove 58 that extends continuously around the second segment 40 of the threaded plunger 36. A resilient split retaining ring 60 is received in the groove 58. A cooperating retaining channel 62 extends circumferentially around the axial bore 26 in the post 12. During installation of the threaded plunger 36 in the post 12, the resilient retaining ring 60 is squeezed so as to be fully received in the groove 58 and pass down in the axial bore 26. Upon reaching the retaining channel 62, the retaining ring 60 expands under resilient memory so as to be partially received in the retaining channel.

The retaining channel 62 is of sufficient height to allow the plunger 36 to be freely adjusted between the first and second positions. This arrangement, however, prevents the plunger 36 from being inadvertently removed from the post 12. Specifically, the retaining ring 60 and retaining channel 62 function to capture the plunger 36 in the post 12. When the plunger 36 is loosened from the post 12, the retaining ring 60 engages both the groove 58 in the plunger 36 and the upper wall 64 of the channel 62 thereby preventing plunger removal. As a result, not only is the plunger 36 retained in the post 12, but the ball bearings 32 are retained in the openings 30.

If the operator needs to change the towing ball 14 for any reason, this may be conveniently and easily accomplished in a quick and efficient manner. First, the plunger 36 is loosened or backed out from the axial bore 26 of the post 12 by turning counterclockwise with respect to the post 12. Once the threaded end of the plunger 36 is free of the threaded portion 28 of the axial bore 26, the spring 43 biases or positively displaces the plunger into the first position shown in FIG. 3. In this position, the head 54 of the plunger 36 projects above the top of the towing ball 14 thereby giving a clear visual indication of the unlocked position. As a result, the first relatively small diameter segment 38 of the plunger 36 is again provided in alignment with the ball bearings 32. Consequently, sufficient clearance then exists in the axial bore 26 to accommodate the ball bearings 32. Thus, as the towing ball 14 is lifted in the direction of action arrow D from the post 12, the ball bearings 32 are accommodated in the axial bore 26 and no longer project outwardly from the wall of the tapered upper portion 24 of the post 12. In view of this and the tapering of the upper portion 24, the towing ball 14 is easily removed. The operator then selects a new towing ball 14 for installation on the post 12 and that installation is completed in the manner already described.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims:

1. An interchangeable hitch ball assembly, comprising:
a towing ball including a mounting aperture and an annular race in communication with said mounting aperture;
a post including a base, a threaded axial bore and a plurality of openings in communication with said axial bore;
a plurality of ball bearings, one of said plurality of ball bearings being received in each one of said plurality of openings;
a threaded plunger including a first segment of relatively small diameter, a second segment of relatively large diameter and a cam surface extending between said first and second segments, said plunger being axially displaceable in said post between a first position wherein said first segment engages said plurality of ball bearings and said plurality of ball bearings are held substantially fully within said plurality of openings in said post and a second position wherein said second segment engages said plurality of ball bearings forcing said plurality of ball bearings to project from said plurality of openings in said post into said annular race of said towing ball so as to secure said towing ball to said post while allowing said towing ball to rotate relative to said post; and
a spring received in said axial bore and engaging an end of said threaded plunger, said spring biasing said threaded plunger into said first position.

2. The interchangeable hitch ball assembly set forth in claim 1, wherein said post further includes a threaded mounting stem depending from said base.

3. The interchangeable hitch ball assembly set forth in claim 1, wherein said post is tapered.

4. The interchangeable hitch ball assembly set forth in claim 1, wherein said towing ball includes a cylindrical opening in communication with said mounting aperture and said plunger includes a slotted head, said slotted head extending through said cylindrical opening so as to be engageable by a tool which may be manipulated to rotate and thereby displace said plunger between said first and second positions.

5. The interchangeable hitch ball assembly set forth in claim 1, wherein edges of said post defining said plurality of openings are staked so as to prevent said plurality of ball bearings from falling out of said post when said towing ball is removed.

6. The interchangeable hitch ball assembly set forth in claim 1, further including a groove extending continuously around said second segment of said threaded plunger and a ring received in said groove.

7. The interchangeable hitch ball assembly set forth in claim 6, further including a retaining channel extending circumferentially around said axial bore in said post, said retaining ring being partially received in and captured by said retaining channel.

8. An interchangeable hitch ball assembly, comprising:
a towing ball including a mounting aperture and an annular race in communication with said mounting aperture;
a post including a base, a threaded axial bore and a plurality of openings in communication with said axial bore;
a plurality of ball bearings, one of said plurality of ball bearings being received in each one of said plurality of openings;
a threaded plunger including a first segment of relatively small diameter, a second segment of relatively large diameter and a cam surface extending between said first and second segments, said plunger being axially displaceable in said post between a first position wherein said first segment engages said plurality of ball bearings and said plurality of ball bearings are held substantially fully within said plurality of openings in said post and a second position wherein said second segment engages said plurality of ball bearings forcing said plurality of ball bearings to project from said plurality of openings in said post into said annular race of said towing ball so as to secure said towing ball to said post while allowing said towing ball to rotate relative to said post; and
a biasing means received in said axial bore and engaging an end of said threaded plunger, said biasing means biasing said threaded plunger into said first position.
